(19) United States
(12) Patent Application Publication
(10) Pub. No.: US 2022/0075347 A1
(43) Pub. Date: Mar. 10, 2022

(54) GEOMETRICAL COMPENSATIONS

(71) Applicant: Hewlett-Packard Development Company, L.P., Spring, TX (US)

(72) Inventors: Enrique Gurdiel Gonzalez, Sant Cugat del Valles (ES); Jordi Sanroma Garrit, Sant Cugat del Valles (ES); Quim Muntal Diaz, Sant Cugat del Valles (ES)

(73) Assignee: Hewlett-Packard Development Company, L.P., Spring, TX (US)

(21) Appl. No.: 17/418,794

(22) PCT Filed: Apr. 30, 2019
(86) PCT No.: PCT/US2019/029831

§ 371 Date: Jun. 26, 2021

(51) Int. Cl. G05B 19/4099; B33Y 50/02; B29C 64/393

(52) U.S. Cl. CPC G05B 19/4099; B33Y 50/02; G05B 2219/49023; G05B 2219/35134; B29C 64/393

(57) ABSTRACT

An example method includes acquiring, by at least one processor, (i) an indication of measured dimensions of objects generated in a common additive manufacturing build operation, wherein the objects include at least one instance of a first object generated based on first object model data and at least one instance of a second object based on second object model data; and (ii) an indication of the orientation of the measured dimensions. Vector components for each of the measured dimensions may be determined based on the indication of the orientation. A first geometrical compensation for use in modifying the first object model data may be determined based on the measured dimensions and the vector components relating to the first object and a second geometrical compensation for use in modifying the second object model data may be determined based on the measured dimensions and the vector components relating to the second object.

### BACKGROUND

Additive manufacturing techniques may generate a three-dimensional object through the solidification of a build material, for example on a layer-by-layer basis. In examples of such techniques, build material may be supplied in a layer-wise manner and the solidification method may include heating the layers of build material to cause melting in selected regions. In other techniques, chemical solidification methods may be used.

### BRIEF DESCRIPTION OF DRAWINGS

Non-limiting examples will now be described with reference to the accompanying drawings, in which:

FIG. 1 is a flowchart of an example method of determining a geometrical compensation for additive manufacturing;

FIG. 2A shows an example of a first object oriented in an object generation orientation;

FIGS. 2B-2D show examples of data for use determining a geometrical compensation for additive manufacturing for multiple instances of the first object shown in FIG. 2A;

FIG. 3A shows an example of a second object oriented in an object generation orientation;

FIGS. 3B-3D show examples of data for use determining a geometrical compensation for additive manufacturing for multiple instances of the second object shown in FIG. 3A;

FIG. 4 is a flowchart of another example method of determining a geometrical compensation;

FIGS. 5 and 6 are simplified schematic drawings of example apparatus for additive manufacturing; and

FIG. 7 is a simplified schematic drawing of an example machine-readable medium associated with a processor.

### DETAILED DESCRIPTION

Additive manufacturing techniques may generate a three-dimensional object through the solidification of a build material. In some examples, the build material is a powder-like granular material, which may for example be a plastic, ceramic or metal powder and the properties of generated objects may depend on the type of build material and the type of solidification mechanism used. In some examples the powder may be formed from, or may include, short fibres that may, for example, have been cut into short lengths from long strands or threads of material. Build material may be deposited, for example on a print bed and processed layer by layer, for example within a fabrication chamber. According to one example, a suitable build material may be PA12 build material commercially referred to as V1R10A “HP PA12” available from HP Inc.

In some examples, selective solidification is achieved through directional application of energy, for example using a laser or electron beam which results in solidification of build material where the directional energy is applied. In other examples, at least one print agent may be selectively applied to the build material, and may be liquid when applied. For example, a fusing agent (also termed a ‘coalescence agent’ or ‘coalescing agent’) may be selectively distributed onto portions of a layer of build material in a pattern derived from data representing a slice of a three-dimensional object to be generated (which may for example be generated from structural design data). The fusing agent may have a composition which absorbs energy such that, when energy (for example, heat) is applied to the layer, the build material heats up, coalesces and solidifies, upon cooling, to form a slice of the three-dimensional object in accordance with the pattern. In other examples, coalescence may be achieved in some other manner.

According to one example, a suitable fusing agent may be an ink-type formulation comprising carbon black, such as, for example, the fusing agent formulation commercially referred to as V1Q60A “HP fusing agent” available from HP Inc. In one example such a fusing agent may comprise at least one of an infra-red light absorber, a near infra-red light absorber, a visible light absorber and a UV light absorber. Examples of print agents comprising visible light enhancers are dye based colored ink and pigment based colored ink, such as inks commercially referred to as CE039A and CE042A available from HP Inc.

In addition to a fusing agent, in some examples, a print agent may comprise a coalescence modifier agent, which acts to modify the effects of a fusing agent for example by reducing or increasing coalescence or to assist in producing a particular finish or appearance to an object, and such agents may therefore be termed detailing agents. In some examples, detailing agent may be used near edge surfaces of an object being printed, for example to reduce or prevent fusing from occurring in that region through ‘thermal bleeding’. According to one example, a suitable detailing agent may be a formulation commercially referred to as V1Q61A “HP detailing agent” available from HP Inc. A coloring agent, for example comprising a dye or colorant, may in some examples be used as a fusing agent or a coalescence modifier agent, and/or as a print agent to provide a particular color for the object.

As noted above, additive manufacturing systems may generate objects based on structural design data. This may involve a designer generating a three-dimensional model of an object to be generated, for example using a computer aided design (CAD) application. The model may define the solid portions of the object. To generate a three-dimensional object from the model using an additive manufacturing system, the model data can be processed to derive slices of parallel planes of the model. Each slice may define a portion of a respective layer of build material that is to be solidified or caused to coalesce by the additive manufacturing system.

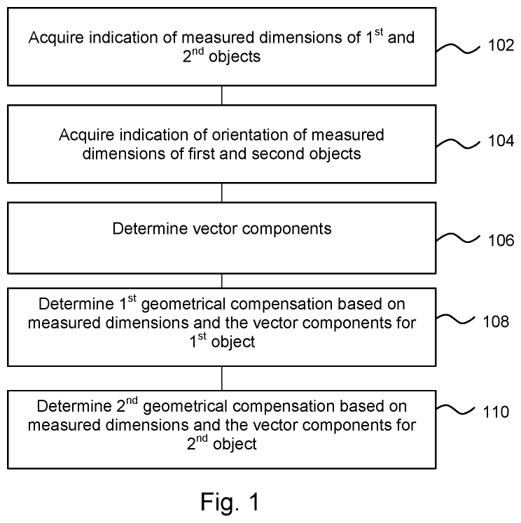

FIG. 1 is an example of a method, which may comprise a computer implemented method for determining a geometrical compensation for use in modifying object model data. For example, such a compensation may be used to modify of object model data in order to compensate for anticipated departures from intended dimensions when generating an object.

For example, in some additive manufacturing processes, where an object is generated in a process which includes heat, additional build material may adhere to the object on generation. In one example, fusing agent may be associated with a region of the layer which is intended to fuse. However, when energy is supplied, build material of neighbouring regions may become heated and fuse to the outside of the object (in some examples, being fully or partially melted, or adhering to melted build material as powder). Therefore, a dimension of an object may be larger than the region(s) to which fusing agent is applied. In order to compensate for this effect, i.e. where it is anticipated that an object may tend to ‘grow’ during manufacture in this (or some other) manner, the object volume as described in object model data may be reduced to compensate for such growth.

In other examples, objects may be smaller following object generation than is specified in object model data. For example, some build materials used to generate objects may shrink on cooling. Therefore, a geometrical compensation/transformation model may specify at least one geometrical compensation parameter to in turn specify how an object volume in object model data should be increased to compensate for the anticipated reduction in size.

A particular object may be subject to mechanisms which result in growth and/or shrinkage, and the actual compensation applied may be influenced by the different degrees to which an object may be affected by such processes.

The method may make use of data gathered from a set of objects generated using an additive manufacturing process. In some examples, these objects may be generated using the same class of additive manufacturing process (for example, all the objects may be generated using selective laser sintering, or all the objects may be generated using a fusing agent printed onto a layer of build material, or all the objects may be generated using some other additive manufacturing process). In other examples, all the objects may be generated using a particular class of apparatus (for example, a powder and fusing agent based 3D printing system). In some examples, all the objects may be generated using the same instance of an additive manufacturing apparatus (i.e. a particular 3D printer).

The method comprises, in block 102, acquiring, by at least one processor, an indication of measured dimensions of objects generated in a common additive manufacturing build operation, wherein the objects include at least one instance of a first object generated based on first object model data and at least one instance of a second object based on second object model data.

The first and second objects may be different from one another in form. The additive manufacturing build operation may be intended to manufacture or generate a plurality of instances of each object. In some examples, as explained in greater detail below, the underlying object data for each object may be modified, and the modification of the data may differ between instances of the same object. Acquiring the indication may comprise acquiring an indication of the measurements themselves, in some examples along with the intended or ‘nominal’ measurements. In some examples, the indications may comprise indications of how measurements depart from the expected (or nominal) measurement. For example, these dimensions may be measured by a 3D scanner, manually, optically, automatically or in some other way.

In some examples, the method may comprise measuring objects generated using additive manufacturing in order to acquire the measurements. In other examples, the objects may be measured separately, and the data provided for example from a memory or over a communications link or the like. In some examples, the method may comprise generating the objects themselves using an additive manufacturing process.

Block 104 comprises acquiring, by at least one processor (which may be the same processor(s) as referred to in relation to block 102), an indication of the orientation of the measured dimensions during the additive manufacturing build operation.

In some examples, the indication of the orientation may be derived from object model data, or from data indicating an object generation location or orientation. For example, a fabrication chamber may be characterised as having X, Y and Z axes. By convention, an object may be formed in XY layers, increasing in height along the Z axis. A ‘virtual’ fabrication chamber (i.e. a model of the intended content of a fabrication chamber) specifying intended locations for object(s) in object generation may be devised prior to generating the object(s). For example, the location of the object vertices of ‘virtual objects’ arranged in the virtual fabrication chamber may be specified as XYZ coordinates, and the coordinates may provide an indication of the orientation of a particular object dimension. In other examples, the orientations may be specified directly. For example it may be specified that the object is rotated such that a measurement which may be associated with the height of the object is non-vertical during object generation. For example, an object may be generated 20° off vertical, with X, Y and/or Z components of the rotation being specified. In another examples, the dimensions under consideration in the object model may be ‘projected’ onto the different axes (using, for example a cosine decomposition), and the ratio for the lengths of the projections may be used to determine an orientation.

In some examples, each instance of the first object may be generated to have the same first orientation and each instance of the second object may be generated to have the same second orientation.

Block 106 comprises determining, by at least one processor (which may be the same processor(s) as referred to in relation to blocks 102 and/or 104), vector components for each of the measured dimensions based (at least in part) on the indication of the orientation. Vector decomposition may be used to describe a single vector as at least two ‘component’ vectors which may be summed to the original vector. As is set out in greater detail below, determining the vector decomposition may comprise determining the vector components of a measured dimension.

In some examples herein, the component vectors may be orthogonal, and in particular examples comprise vectors having directions aligned with the X, Y and Z axes. The magnitude of each of the component vectors will depend on the magnitude and orientation of the dimension.

Block 108 comprises determining, by at least one processor, (which may be the same processor(s) as referred to in relation to blocks 102, 104 and/or 106), a first geometrical compensation for use in modifying the first object model data based on the measured dimensions and the vector components relating to the first object. Block 110 comprises determining, by at least one processor, (which may be the same processor(s) as referred to in relation to blocks 102, 104, 106 and/or 108) a second geometrical compensation for use in modifying the second object model data based on the measured dimensions and the vector components relating to the second object

In this way, measured dimensions which are not aligned to a given axis may be used to determine a compensation value to be applied in a particular axis.

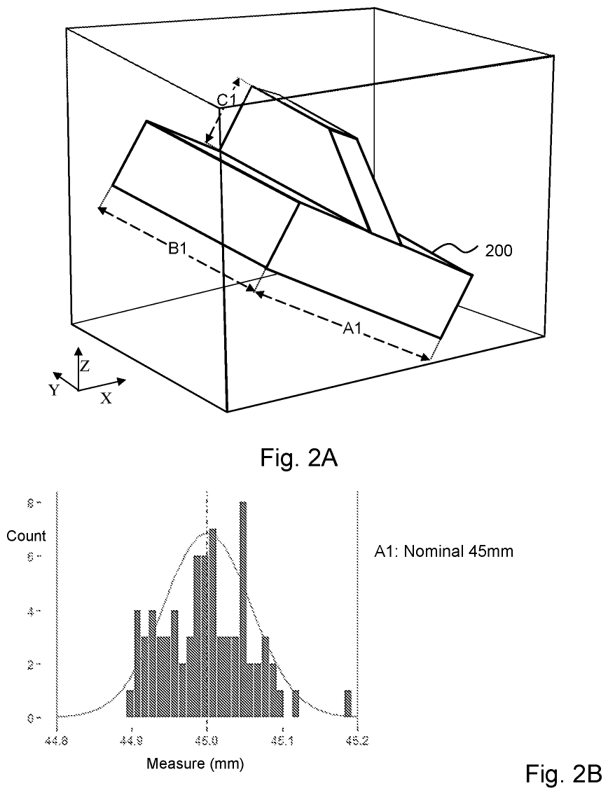

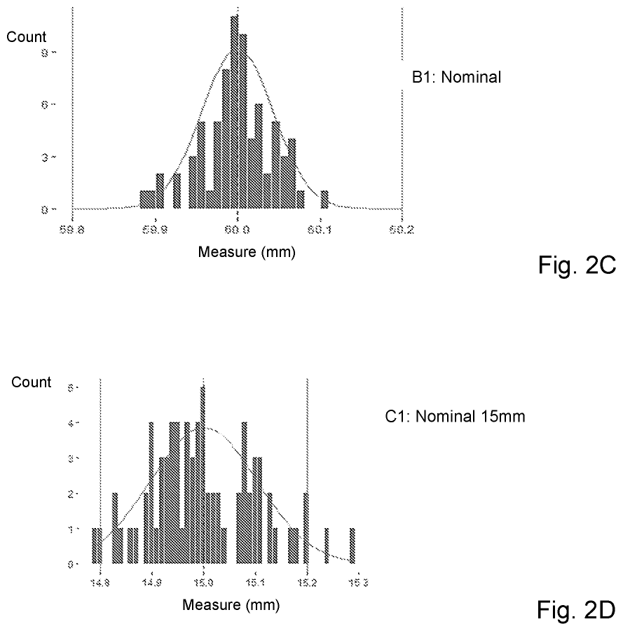

To consider a practical example, FIG. 2A shows an example of an object 200 showing its object generation orientation in a fabrication chamber. Three dimensions which may be measured to provide the measured dimensions of block 102 are marked as A1, B1 and C1. B1 is aligned with the Y axis, whereas A1 and C1 extend in the XZ plane, with A1 having a greater horizontal component and C1 having a greater vertical component. Therefore, both A1 and C1 are non-parallel to at least one axis. In this example, the measurements may be decomposed down as follows:

| | | | Vector |
|---|---|---|---|
| | Nominal | Orientation | decomposition |
| A1 | 45 mm | X %: 75% | X = 38.97 |
| | | Y %: 0% | Y = 0 |
| | | Z %: 25% | Z = 22.50 |
| B1 | 60 mm | X %: 0% | X = 0 |
| | | Y %: 100% | Y = 60 |
| | | Z %: 0% | Z = 0 |
| C1 | 15 mm | X %: 25% | X = 7.50 |
| | | Y %: 0% | Y = 0 |
| | | Z %: 75% | Z = 12.99 |

The decomposition of the vectors representing the nominal into its vector component magnitudes to the respective axes is shown in the right hand column. This is determined using the relationship, where i is the value for the orientation in x, y or z:

$$Magnitude ( i ) = Nominal * \sqrt{\frac{i \%}{100}}$$

It may be noted that the magnitude of the vector components of the nominal measurements may be determined using the orientation where it is provided, or the vector components may be determined by projecting the object model data onto the axes, and used to determine the orientation.

Measured data as described in relation to block 102 may be acquired for a set of objects—for example hundreds of such objects. FIG. 2B-D show examples of measurement distributions of the measurements A, B and C for a plurality of objects having the form shown in FIG. 2A, and printed in the same orientation. In this particular example, the objects were printed in a single build operation, which comprised objects of this form, and no other types of object. FIGS. 2B, 2C and 2D show the number of measured dimensions falling into 0.01 mm resolution bins. It may be noted that, if more measurements were acquired (from this object or another object, or indeed from the same object in a different orientation, which measurements may be treated separately as the processes resulting in deformation are not isotropic), this may result in additional error distributions.

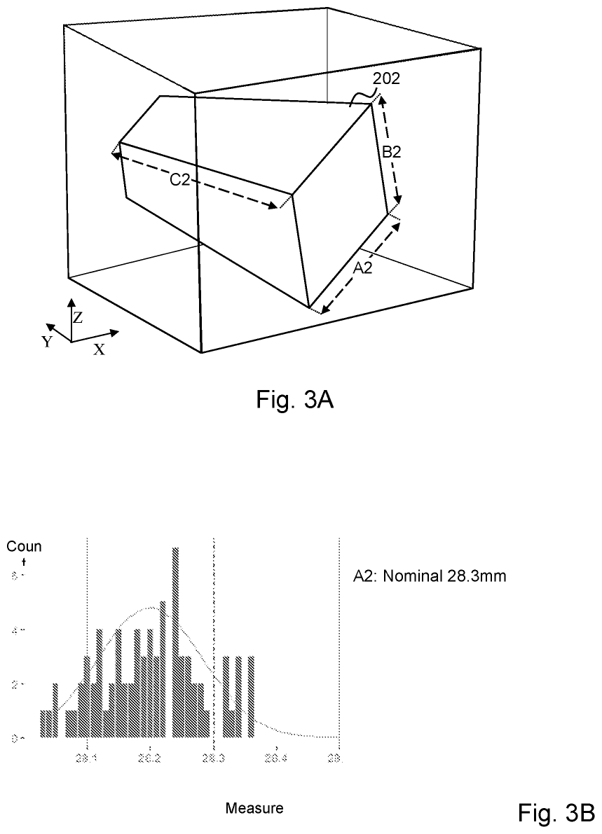

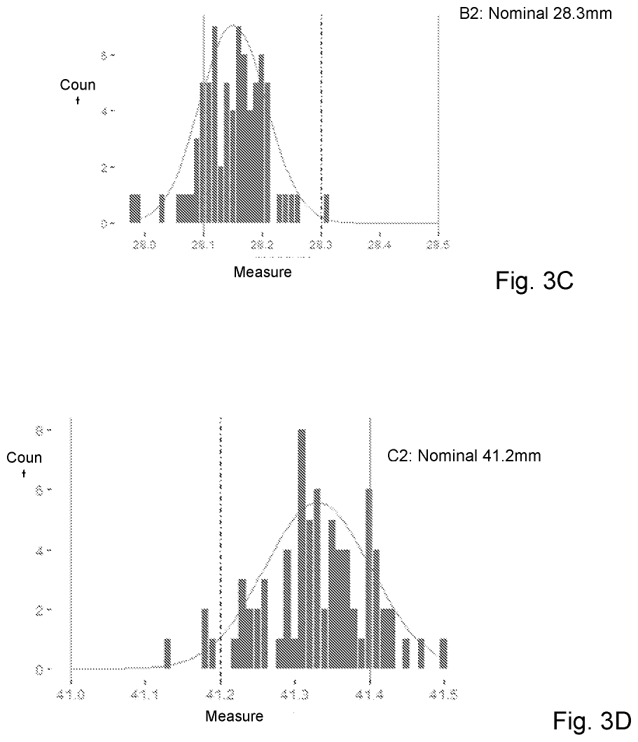

FIG. 3A shows a second object 202, with three marked measured dimensions:

| | | | Vector |
|---|---|---|---|
| | Nominal | Orientation | decomposition |
| A2 | 28.3 mm | X %: 74.94% | X = 24.49 |
| | | Y %: 2.77% | Y = 14.89 |
| | | Z %: 22.29% | Z = 13.36 |
| B2 | 28.3 mm | X %: 21.44% | X = 13.10 |
| | | Y %: 39.02% | Y = 17.68 |
| | | Z %: 39.54% | Z = 17.68 |
| C2 | 41.2 mm | X %: 17% | X = 16.99 |
| | | Y %: 43.77% | Y = 27.26 |
| | | Z %: 39.23% | Z = 25.81 |

Deviations from intended dimensions may be characterised as:

Measurement=Nominal measurement+Error due to deformation

As can be seen, in this example, for the first object 200, the A1 and C1 dimensions are generally larger than intended, the B1 dimension is generally smaller than is intended. It may be noted that the C1 population is relatively spread. This is an attribute of some additive manufacturing apparatus, where the greatest inaccuracy may be seen in the Z dimension, noting that the Z component of C1 is relatively large. For the second object 202, the A2 and C2 dimensions are generally larger than intended, the B2 dimension is generally smaller than is intended. The Figures also show lines marking a 0.2 mm tolerance band.

The compensation derived in this example is intended to centre the measurement distributions on the nominal, or expected, dimensions for each object 200, 202. To determine the compensation to be applied in one example, an ‘optimisation problem’ may be solved. In this particular example, the optimisation is carried out to determine the parameters (i.e. geometrical compensation values) of a compensation model that reduce the bias of the measured error distributions (i.e. the parameters which provide an error distribution having a mean equal to 0, or a measurement distribution having a mean equal to the nominal for the measurements).

In this example, the geometrical compensation values may comprise scaling and/or offset factors in each of the X, Y and Z axes. A scaling factor may be used to multiply all specified dimensions in the direction of an axis by a value, which may be greater than 1 in order to increase the dimensions and less than 1 to reduce the dimensions. An offset factor may specify, for example by a specified distance (which may be specified in predefined units, for example in millimetres, or in addressable units such as pixels or ‘voxels’), an amount to add or remove from a surface of the object (or a perimeter within a layer). For example, a distance as measured in the direction of a normal from the object surface may be specified and the object may be eroded or dilated (i.e., inflated or enlarged) by this distance.

In some examples, where scaling is not indicated in a given dimension, the scaling factor in relation to that dimension may be set to 1, and if no offset is indicated in a given dimension, the offset factor in relation to that dimension may be set to 0.

For a given axis, a scale correction may be represented as a factor of s and an offset correction with a length of o as follows:

M′=M*s+o

Where M is the acquired measurement (i.e., the measured dimension) and M′ the value with the transformations simulated. The components of the vector decomposition may be multiplied with measured dimensions to determine the magnitude of a measurement along an axis. When generalised to three dimensions, this can be expressed as:

$${M}^{′} = \sqrt{{\sum }_{i = x , y , z} {( \sqrt{( \frac{i \%}{100} )} * M * {s}_{i} + {o}_{i} )}^{2}}$$

Where the term

$$\sqrt{( \frac{i \%}{100} )}$$

has been introduced above in relation to the orientation of the nominal measurements, and provides the magnitudes of the vector component of the measured dimensions.

In general, this relationship may be solved to find s and o such that M′ is, at least on average, the nominal, or expected, dimension. In other words, the equation may be solved to determine geometrical compensation values of sx, sy, sz, ox, oy and oz which minimize the mean, with respect to the identified dimensions, of the squared differences between the nominal measurement and the mean value of the predicted measurement distribution. In some examples, to prevent anomalous effects and/or over correction due to, for example, erroneous measurements, bounds may be set. In this example, the maximum permissible change in scale is 0.1 (i.e. the scale may be at most 1.1000 or 0.9000) and the maximum permissible change in offset is ±0.1500 mm. Other bounds may be set in other examples.

The scaling and offsets are determined for each object separately. In other words, a first geometrical compensation is derived for use in modifying the first object model data based on the measured dimensions and the vector components relating to the first object 200 (and without use of the measured dimensions and the vector components relating to the second object 202) and a second geometrical compensation is derived for use in modifying the second object model data based on the measured dimensions and the vector components relating to the second object 202 (and without use of measured dimensions and the vector components relating to the first object 202).

In the example of the first object 200, a minimisation operation gives scaling and offsets as follows:

| sx | sy | sz | ox | oy | oz |
|---|---|---|---|---|---|
| 1.0010 | 0.9971 | 1.0050 | 0.0461 mm | −0.0539 mm | 0.0435 mm |

In the case of the second object 202, the data set of the transformations are capped at the bounds. The “A2” measurement distribution is well centered in the simulation but the other two distributions cannot be perfectly centered within the transformation bounds above. Nevertheless, the dimensional accuracy may be improved by applying the transformation at the bounds.

In the example of the second object 202, a minimisation operation gives scaling and offsets as follows:

| sx | sy | sz | ox | oy | oz |
|---|---|---|---|---|---|
| 1.0039 | 1.0100 | 0.0066 | 0.1500 mm | 0.1500 mm | 0.1500 mm |

Where the offset transformations are capped at the bound of ±0.1500 mm.

Such scaling factors and offset factors may be used in a subsequent build operation to generate a further set of objects which may be closer to the intended dimensions.

For the sake of comparison, if instead this was treated as a single optimisation, in the above example, there may be some improvement. However, the inventors have discovered that in particular the measure of the capability index (which is a statistical measure of the ability of a process to produce output within specification limits) was more significantly improved by determining the two compensations independently from one another. In particular, carrying out a single optimisation operation for the data provided in the Figures with the same bounds gave:

| sx | sy | sz | ox | oy | oz |
|---|---|---|---|---|---|
| 1.0034 | 0.9989 | 1.0100 | −0.150 mm | −0.150 mm | 0.025 mm |

Two further sets of objects were then generated, having the same arrangement as the objects from which the data of the Figures was gathered, making use of the determined scaling and offset values.

For the original set of objects (i.e., that from which the measurements were obtained), the average Cpk value was 0.22. When treated as a single optimisation, this was improved to 0.73 by use of the single set of scaling and offset values. However, when treated as two optimisations, a more significant improvement to 0.90 was noted by use of the scaling and offset values determined for, and applied to, the first and second objects separately. A table showing the Cpk values for each measurement is shown below:

| Cpk | A1 | B1 | C1 | A2 | B2 | C2 | MEAN |
|---|---|---|---|---|---|---|---|
| Original | 0.19 | −0.22 | 0.32 | 0.4 | 0.3 | 0.32 | 0.22 |
| Single | 0.71 | 1.79 | 0.54 | 0.44 | 0.47 | 0.41 | 0.73 |
| optimization | | | | | | | |
| Object by | 1.15 | 1.53 | 0.64 | 0.84 | 0.63 | 0.56 | 0.90 |
| object | | | | | | | |
| optimization | | | | | | | |

While in these examples, six different transformation values are determined for each object, in other examples all six need not be calculated. For example, scale could be set to 1 for at least one axis and/or the offset could be set to 0. This may decrease the processing resources utilised. In addition, while the offset factor is specified herein as a distance in millimetres, it may be specified in some other way, for example in terms of voxels.

Other methods may be used to derive offset and/or scale parameters, for example including those which seek to minimise the distribution of the measurements, solutions which penalise measurement sets having a high number of anomalous measurements (e.g. those outside of a threshold range of the nominal), solutions which favour a predetermined data spread, for example, those which are within a predetermined tolerance of the mean (even if this shifts the mean away from resulting in the nominal measurement), or some other factor, based on a particular intended outcome. Other methods may use data fitting methods such as linear regression or the like.

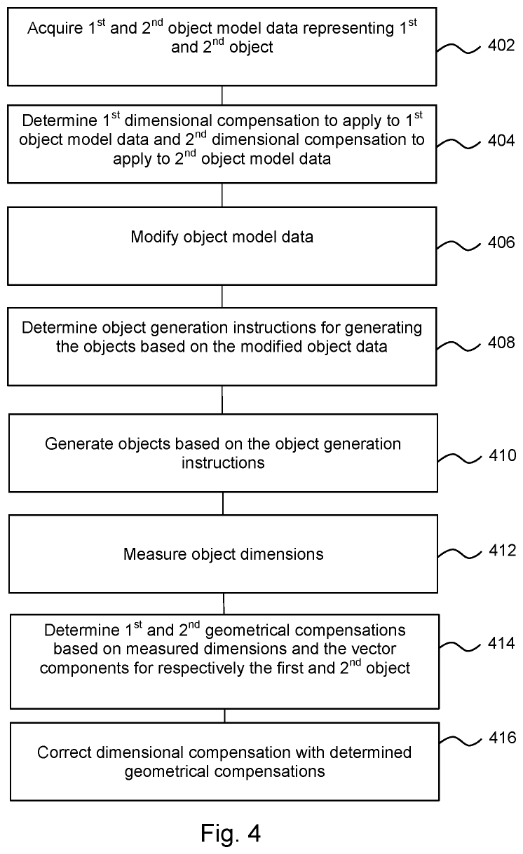

FIG. 4 is an example of a method which may be used in conjunction with the methods discussed above. In this example, a build operation is to generate a predetermined set of objects comprising the first and second object and the geometrical compensation is for use in modifying object model data for a further instance of the (same) build operation. Moreover, the build operations are intended to generate a plurality of instances of each of the first and second objects, wherein all the instances of a given object are to be generated in a common orientation for that object, and no other objects are to be included in the build operations.

This may simplify data gathering and analysis, and the robustness of the compensation derived, although the method may be used with a range of additional objects. In some examples, objects (and/or the orientation thereof) may be relatively similar to the first and/or second objects in applications of the method as this enhances its effectiveness. For example, the volume of objects may be similar, and/or they may have relatively similar forms and relatively similar measured dimensions. Moreover, while two objects are discussed herein, in other examples, there may be a third or further object, for which a third or further specific compensation may be derived.

Block 402 comprises acquiring first and second object model data representing, respectively, the first and second objects. The object model data may comprise data representing at least a portion (in some examples, a slice) of an object to be generated by an additive manufacturing apparatus by fusing a build material. The object model data may for example comprise a Computer Aided Design (CAD) model, and/or may for example be a STereoLithographic (STL) data file. In some examples, the object model data may represent the object or object portion as a plurality of sub-volumes, wherein each sub-volume represents a region of the object which is individually addressable in object generation. In some examples herein, the sub-volumes may be referred to as voxels, i.e. three-dimensional pixels. The data may be acquired from a memory, or over a network, or the like.

Block 404 comprises determining, using at least one processor, at least one first dimensional compensation value to apply to the first object model data and at least one second dimensional compensation value to apply to the second object model data.

In some examples, the first and second dimensional compensation values may be the same, while in other examples they may be different. In this example, these are not the geometrical transformations derived as described in FIG. 1, but is a different compensation value or values. In some examples, the dimensional compensation values may describe a parametrical transformation, for example a geometrical transformation such as at least one of an offset and a scaling factor, for example up to three scaling factors (one for each of the three orthogonal dimensions) and up to three offset values (one for each of the three orthogonal dimensions). In some examples, the dimensional compensation value may be taken from a geometrical compensation model. In examples, such models may map object generation parameters to compensations to apply. In some examples, different dimensional compensation values may be applied to generate different instances of each of the first and second objects.

For example, a geometrical compensation model may take account of an intended location of an object in a fabrication chamber. It has been noted that dimensional deformation has a relationship to the location of object generation, and therefore different compensation parameters may be applied for different object locations to improve accuracy. Such geometrical compensation models may therefore comprise or provide compensation parameters which may be mapped to the intended location of an object (which may for example be a single identifiable point such as the location of the centre of mass of the object, or may include a consideration of the volumetric extent of the object).

For example, if an object is to be generated at a first location within the fabrication chamber, the location may be mapped to a geometrical compensation comprising one or more offset and/or scaling value. However, if the same object were to be generated at a second location within the fabrication chamber, this second location may be mapped to a different geometrical compensation comprising one or more different offset and/or scaling value. Thus, the particular geometrical compensation applied may vary between different locations based on predetermined mappings or the like.

In some examples, at least one geometrical compensation model may comprise a plurality of defined geometrical compensation values (or value sets), each associated with different locations within the fabrication chamber. In such examples, a particular geometrical compensation value may be selected based (at least in part) on the intended object generation location. In some examples, defined locations may be associated with geometrical compensation value(s), and the geometrical compensation value(s) to apply at locations intermediate to such defined locations may be generated for example by interpolation, or by selection of the closest defined location, or the like.

In other examples, characteristics of the object, such as consideration of the object volume and/or surface area, may be used as input parameters in a geometrical compensation model.

For example, bulkier objects (i.e. objects having a larger volume) may accrue greater thermal energy than smaller objects, and may therefore tend to accumulate more heat than smaller objects. Cooling such objects may therefore take more time than cooling less bulky objects. This may lead to different deformations. Thus, in one example a first compensation model may comprise a compensation value associated with object volume while in other examples there may be no such compensation value, or a different compensation value may be used.

The surface area (and combinations of the volume and surface area) may be used to determine how ‘solid’ an object is. The amount of solid material in an object may be used to predict how the object may deform. For example, a more solid object may tend to accumulate more heat than a less solid object in a thermal fusing additive manufacturing operation and may cool differently. Such object generation parameters may therefore be mapped to different geometrical compensation parameters within a geometrical compensation model.

Other geometrical compensation models may for example include a consideration of how many objects are to be generated in a fabrication chamber and/or the proximity of the objects (for example in terms of ‘packing density’).

In other examples, other object generation parameter values (which may be object generation parameter values which are configurable or selectable by a user or operator) may be considered. The object generation parameter(s) may be any parameter which may have an impact on dimensional inaccuracy. For example, the object generation parameter(s) may comprise any, or any combination of, environmental conditions, object generation apparatus, object generation material composition (which may comprise selection of the type or composition of build material and/or print agents), object cooling profile, print mode, or the like. These may be specified, for example, by input to at least one processor. Thus, different geometrical compensation models and/or different parameters may be provided for different apparatus, different print modes, different cooling profiles or the like.

The geometrical compensation parameter(s) and/or geometrical compensation model(s) specifying such parameters may for example be stored in a memory, for example embodied as a mapping resource(s) such as lookup tables and the like, or may be embodied as one or more algorithm, for example relating object generation parameter(s) (e.g. any or any combination of object generation location, volume, surface area, packing density, environmental conditions, object generation apparatus, object generation material composition, object cooling profile or print mode) to a compensation to be applied to object model data.

Block 406 comprises modifying the object model data with the determined compensation. In some examples, different modifications may be carried out with respect to different intended instances of the first object, and with respect to different intended instances of the second object, for example based on an object generation parameter as set out above.

Block 408 comprises determining object generation instructions (or ‘print instructions’) based on (at least in part) the modified object model data. The object generation instructions in some examples may specify an amount of print agent to be applied to each of a plurality of locations on a layer of build material. For example, determining object generation instructions may comprise determining ‘slices’ of a virtual build volume (or fabrication chamber) comprising virtual object(s) (to which a modification may have been applied) and rasterising these slices into pixels (or voxels, i.e. three-dimensional pixels). An amount of print agent (or no print agent) may be associated with each of the pixels/voxels. For example, if a pixel relates to a region of a fabrication chamber which is intended to solidify, the object generation instructions may be determined to specify that fusing agent should be applied to a corresponding region of build material in object generation. If however a pixel relates to a region of the fabrication chamber which is intended to remain unsolidified, then object generation instructions may be determined to specify that no agent, or a coalescence modifying agent such as a detailing agent, may be applied thereto, for example to cool the build material. In addition, the amounts of such agents may be specified in the determined instructions and these amounts may be determined based on, for example, thermal considerations and the like. In other examples, object generation instruction may specify how to direct directed energy, or how to place a curing or binding agent or the like.

Block 410 comprises generating the set of instances of the first object and the second object in a common build operation. Generating the objects may comprise generating the objects based on object generation instructions (or ‘print instructions’). For example, the objects may be generated layer by layer. For example, this may comprise forming a layer of build material, applying print agents, for example through use of ‘inkjet’ liquid distribution technologies in locations specified in the object generation instructions for an object model slice corresponding to that layer using at least one print agent applicator, and applying energy, for example heat, to the layer. Some techniques allow for accurate placement of print agent on a build material, for example by using print heads operated according to inkjet principles of two-dimensional printing to apply print agents, which in some examples may be controlled to apply print agents with a resolution of around 600 dpi, or 1200 dpi. A further layer of build material may then be formed and the process repeated, for example with the object generation instructions for the next slice. In other examples, objects may be generated using directed energy, or through use of chemical binding or curing, or in some other way.

Block 412 comprises measuring predetermined object dimensions of the first and second objects. For example, these dimensions may be measured by a 3D scanner, manually, optically, automatically or in some other way.

Block 414 comprises determining a first and a second geometrical compensation for use in modifying the object model data based on measured dimensions and the vector components, for example as described above with respect to FIGS. 1 and 2A-D.

Block 416 comprises combining the geometrical compensations determined in block 414 with the dimension compensation(s) determined in block 404, and using this combination to modify object model data representing the first and second objects for a subsequent build operation. In other words, the determined geometrical compensations are used to correct a geometrical compensation used to generate the measured objects. In this example (as in many use cases of additive manufacturing) multiple batches of the first and second objects are to be generated. The method may therefore comprise using the object model data to determine a further set of object generation instructions and generating a further set of objects. By using the methods set out herein, subsequent batches may conform better to intended dimensions.

In this example, a common first defined modification may be applied for each instance of the first object and a common second defined modification may be applied for each instance of the second object. In other words, while a geometrical compensation model used to generate the objects in block 410 may result in different modifications being made to object model data, the change to that model may be consistent for all first objects and for all second objects. For example, a location dependent model may specify a scale and offset factor in a given axis of sᵢ and oᵢ for location i and of sⱼ and oⱼ for location j, but both of these may be modified by the same ‘correction’ to result in sᵢ*s_{new} and oᵢ+o_{new} for location i and sⱼ*s_{new} and oⱼ+o_{new} for location j, assuming they relate to the same object (i.e. the objects to be generated at position i and j are both first objects, or are both second objects). This may compensate well for ‘shifts’ in object dimension accuracy, in which a particular apparatus and/or object may result in a consistent offset compared to an expectation given a general compensation model.

Modelling the complex thermal relationships experienced during object generation is both intellectually and computationally difficult. However, by tailoring a modification based on decomposition of measurements, the range of measurements which may contribute to a compensation model may be increased. Moreover, by tailoring a modification/compensation model to a particular object in a particular orientation, accuracy may be increased.

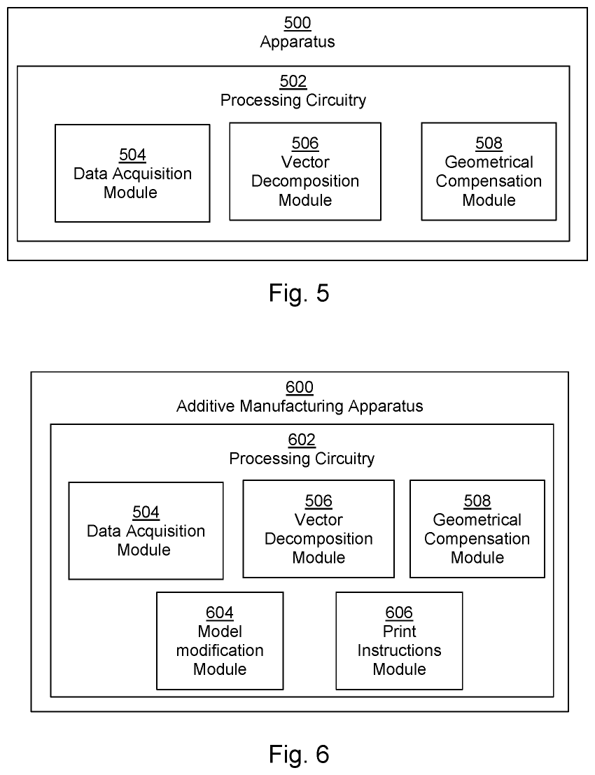

FIG. 5 shows an apparatus 500 comprising processing circuitry 502. The processing circuitry 502 comprises a data acquisition module 504, a vector decomposition module 506 and a geometrical compensation module 508.

In use of the apparatus 500, the data acquisition module 504 acquires data indicative of measured object dimensions for first and second objects generated by an additive manufacturing apparatus. This may for example comprise the measurements themselves, as has been described above, or an indication of the deviation from the expected measurements. In some examples, the first and second objects may be a set of objects generated in a common operation. In some examples, each first object may be based on the same underlying object model data and/or each second object may be based on the same underlying object model data (albeit possibly modified in different ways).

In use of the apparatus 500, the vector decomposition module 506 decomposes object dimensions into orthogonal axis components. The decomposed object dimensions may be based on the direction of nominal dimensions as oriented in an object generation orientation (e.g. as derived from object model data), and/or the decomposition may be a decomposition into an X, Y and Z axis.

The geometrical compensation module 508 derives a first and a second geometrical compensation describing at least one geometrical transformation to be applied to object model data representing objects in the direction of at least one of the orthogonal axes based on the orthogonal axis components. The first geometrical compensation describes at least one geometrical transformation to be applied to object model data representing the first object and is derived based on the measured dimensions and the vector decomposition components relating to the first object. The second geometrical compensation describes at least one geometrical transformation to be applied to object model data representing the second object and is derived based on the measured dimensions and the vector components relating to the second object.

In some examples, the geometrical compensation specifies at least one of a scaling factor and an offset factor. In some examples, the geometrical compensation comprises three scaling factors and three offset factors, wherein each of the scaling factors and each of the offset factors is associated with one of three orthogonal axes and wherein the orthogonal axis components are aligned with the orthogonal axes.

FIG. 6 shows additive manufacturing apparatus 600 to generate an object comprising processing circuitry 602 comprising, in addition to the data acquisition module 504, vector decomposition module 506 and geometrical compensation module 508 of FIG. 5, a model modification module 604 and a print instructions module 606 for determining print instructions for generating the object from data representing the modified virtual object.

The model modification module 604, in use of the apparatus 600, modifies object model data representing the first and second objects using, respectively the determined first and second geometrical compensations to generate at least one of each object in a subsequent additive manufacturing build operation. In some examples, common underlying object model data for a given one of the first and second object is modified to create modified object model data to generate each of a plurality of instances of that objects. In some examples, the subsequent additive manufacturing build operation is to generate multiple instances of the first and second objects, and no other object. In some examples, subsequent additive manufacturing build operation is to generate multiple instances of the same objects as those from which the measured dimensions were obtained. In some examples, the multiple instances of each of the first and second objects are generated to have a common orientation (which may be the same as the orientation of the first and second objects from which the measured dimensions were obtained). In some examples, the content of the subsequent build operation may be substantially the same (i.e. comprising of objects generated in the same position, orientation, number and/or having the same form) as the build operation from which the measurements are acquired (albeit in some cases with different modifications made to the underlying object model data).

The print instructions module 605, in use of the additive manufacturing apparatus 600, determines print instructions for generating the objects from data representing the modified virtual objects. The print instructions (or object generation instructions) may, in use thereof, control the additive manufacturing apparatus 600 to generate each of a plurality of layers of the objects. This may for example comprise specifying area coverage(s) for print agents such as fusing agents, colorants, detailing agents and the like. In some examples, object generation parameters are associated with object model sub-volumes (voxels or pixels). In some examples, the print instructions comprise a print agent amount associated with sub-volumes. In some examples, other parameters, such as any, or any combination of heating temperatures, build material choices, an intent of the print mode, and the like, may be specified. In some examples, halftoning may be applied to determine where to place fusing agent or the like.

The additive manufacturing apparatus 600, in use thereof, generates the objects in a plurality of layers (which may correspond to respective slices of an object model) according to the print instructions. The additive manufacturing apparatus 600 may for example generate an object in a layer-wise manner by selectively solidifying portions of layers of build material. The selective solidification may in some examples be achieved by selectively applying print agents, for example through use of ‘inkjet’ liquid distribution technologies, and applying energy, for example heat, to the layer. The additive manufacturing apparatus 600 may comprise additional components not shown herein, for example any or any combination of a fabrication chamber, a print bed, printhead(s) for distributing print agents, a build material distribution system for providing layers of build material, energy sources such as heat lamps and the like.

The processing circuitry 502, 602 or the modules thereof may carry out any or any combination of the blocks of FIG. 1, and/or any of blocks 402 to 408, 415 or 417 of FIG. 4.

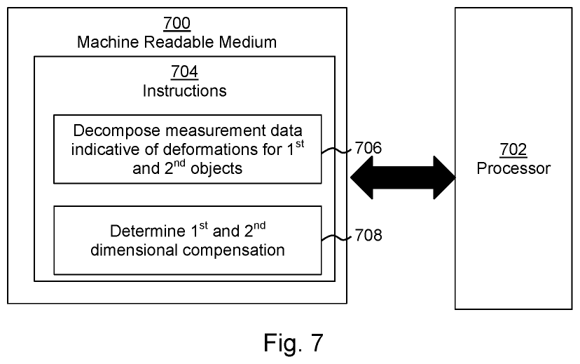

FIG. 7 shows a tangible machine-readable medium 700 associated with a processor 702. The machine-readable medium 700 comprises instructions 704 which, when executed by the processor 702, cause the processor 702 to carry out tasks. In this example, the instructions 704 comprise instructions 7074 to cause the processor 702 to decompose object dimensions of a first set of 3D printed objects comprising a plurality of instances of each of a first and a second, different, object into orthogonal vectors and instructions 708 to determine at least one compensation parameter to apply in the direction of each of the orthogonal vectors, wherein the compensation parameters are derived separately for each of the first and the second object and wherein the compensation parameter is to compensate for deformations in subsequent 3D printing of the set of objects. The vector decomposition may be derived from the orientation of the measurements, which may in turn be derived from or provided with object model data. The at least one compensation parameter may be determined using data indicative of measurements of the dimensions in 3D printed objects.

The machine-readable medium 700 may store instructions to carry out any or any combination of the blocks of FIG. 1, and/or any of blocks 402 to 408, 414 or 416 of FIG. 4.

Examples in the present disclosure can be provided as methods, systems or machine readable instructions, such as any combination of software, hardware, firmware or the like. Such machine readable instructions may be included on a computer readable storage medium (including but not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that each block in the flow charts and/or block diagrams, as well as combinations of the blocks in the flow charts and/or block diagrams can be realized by machine readable instructions.

The machine readable instructions may, for example, be executed by a general purpose computer, a special purpose computer, an embedded processor or processors of other programmable data processing devices to realize the functions described in the description and diagrams. In particular, a processor or processing apparatus may execute the machine readable instructions. Thus functional modules of the apparatus (such as the data acquisition module 504, the vector decomposition module 506 the geometrical compensation module 508, the model modification module 604 and/or the print instructions module 606) may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine readable instructions may also be stored in a computer readable storage that can guide the computer or other programmable data processing devices to operate in a specific mode.

Machine readable instructions may also be loaded onto a computer or other programmable data processing devices, so that the computer or other programmable data processing devices perform a series of operations to produce computer-implemented processing, thus the instructions executed on the computer or other programmable devices realize functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus and related aspects be limited by the scope of the following claims and their equivalents. It should be noted that the above-mentioned examples illustrate rather than limit what is described herein, and that those skilled in the art will be able to design many alternative implementations without departing from the scope of the appended claims. Features described in relation to one example may be combined with features of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A method comprising:
acquiring, by at least one processor,
(i) an indication of measured dimensions of objects generated in a common additive manufacturing build operation, wherein the objects include at least one instance of a first object generated based on first object model data and at least one instance of a second object based on second object model data; and
(ii) an indication of the orientation of the measured dimensions;
determining, by at least one processor, vector components for each of the measured dimensions based on the indication of the orientation; and
determining, by at least one processor, a first geometrical compensation for use in modifying the first object model data based on the measured dimensions and the vector components relating to the first object and a second geometrical compensation for use in modifying the second object model data based on the measured dimensions and the vector components relating to the second object.

2. A method according to claim 1 in which the build operation generated a predetermined set of objects and the geometrical compensation is for use in modifying object model data for a further instance of the build operation.

3. A method according to claim 1 wherein the build operation generated a plurality of instances of the first object and the second object.

4. A method according to claim 3 wherein the plurality of instances of the first object were generated having a common orientation, and the plurality of instances of the second object were generated having a common orientation.

5. A method according to claim 1 in which determining the vector components comprises decomposing an object dimension into three orthogonal axes, and wherein the geometrical compensation comprises geometrical compensation values relating to each of the three orthogonal axes.

6. A method according to claim 5 in which at least one of the measured dimensions is non-parallel to at least one of the three orthogonal axes.

7. A method according to claim 1 in which determining the geometrical compensation for use in modifying object model data comprises solving an optimisation problem relating measured dimensions to expected dimensions.

8. A method according to claim 1 further comprising using the determined geometrical compensation to correct a geometrical compensation used to generate the measured objects.

9. A method according to claim 1 further comprising generating objects in an additive manufacturing operation and measuring the generated objects to determine the generated object dimensions.

10. Apparatus comprising processing circuitry, the processing circuitry comprising:
a data acquisition module to acquire data indicative of measured object dimensions for first and second objects generated by an additive manufacturing apparatus;
a vector decomposition module to decompose object dimensions into orthogonal axis components; and
a geometrical compensation module to derive a first and a second geometrical compensation, wherein each geometrical compensation describes at least one geometrical transformation to be applied to object model data representing objects in the direction of at least one of the orthogonal axes based on the orthogonal axis components, wherein
the first geometrical compensation describes at least one geometrical transformation to be applied to object model data representing the first object and is derived based on the measured dimensions and the vector decomposition components relating to the first object; and
the second geometrical compensation describes at least one geometrical transformation to be applied to object model data representing the second object and is derived based on the measured dimensions and the vector components relating to the second object.

11. Apparatus according to claim 10 in which each geometrical compensation specifies at least one of a scaling factor and an offset value.

12. Apparatus according to claim 10 in which the data acquisition module is to acquire data indicative of measured object dimensions of a predetermined set of objects including the first and second objects generated by a common additive manufacturing build operation; and wherein
the apparatus further comprises a model modification module to modify object model data representing the first and second objects based on the respective first and second geometrical compensations to generate the predetermined set of objects in a subsequent common additive manufacturing build operation.

13. Apparatus according to claim 10 further comprising a print instructions module to determine print instructions for generating at least one object based on object model data, the print instructions specifying an amount of print agent to be applied to each of a plurality of locations on a layer of build material.

14. Apparatus according to claim 13 further comprising object generation apparatus to generate an object based on the print instructions.

15. A machine-readable medium storing instructions which, when executed by a processor, cause the processor to:
decompose object dimensions of a first set of 3D printed objects comprising a plurality of instances of each of a first and a second, different, object into orthogonal vectors; and
determine at least one compensation parameter to apply in the direction of each of the orthogonal vectors, wherein the compensation parameters are derived separately for each of the first and the second object and wherein the compensation parameter is to compensate for deformations in subsequent 3D printing of the set of objects.
